(19) United States
(12) Patent Application Publication
(10) Pub. No.: US 2014/0279582 A1
(43) Pub. Date: Sep. 18, 2014

(54) DYNAMIC LICENSING METHOD

(71) Applicant: Ywein Van Den Brande, Mechelen (BE)

(72) Inventor: Ywein Van Den Brande, Mechelen (BE)

(21) Appl. No.: 14/206,159

(22) Filed: Mar. 12, 2014

Related U.S. Application Data
(60) Provisional application No. 61/779,755, filed on Mar. 13, 2013.

(51) Int. Cl. G06Q 50/18; G06F 21/10

(52) U.S. Cl. CPC G06Q 50/184; G06F 21/10
USPC 705/310; 726/26

(57) ABSTRACT

A computer implemented dynamic licensing method and system which includes a registration module and a licensing module. The registration module is configured to receive and store registration and licensing information relating to one or more authors of one or more creative works. The registration module further generates an identification code for the author(s). The licensing module is configured to receive requests for licensing information for a creative work associated with an author. Upon such request, the licensing module identifies the author or owner of the creative work. The licensing module then provides any available licensing information for the creative work identified in the request. Preferred embodiments of the present invention are provided by one or more web-based computing devices providing users the ability to communicatively connect with the web-based computing devices in order to: (i) list a work as available for licensing; and (ii) purchase and retrieve a license to use a work for an intended purpose.

### CROSS-REFERENCE TO RELATED APPLICATIONS

This application claims the benefit of provisional patent application, U.S. Pat. App. No. 61/779,755 filed on Mar. 13, 2013, which is hereby incorporated by reference in its entirety.

### FIELD OF THE INVENTION

The present invention is a computer implemented licensing system and method that generates an identifier associated with one or more of an author and a creative work such that the identifier may be used by third parties to retrieve licensing or purchasing information related to a creative work associated with the author and commit such a transaction with the system for the purchase or license of the creative work.

### BACKGROUND

When a user wants to obtain a license on a Work on the Internet, he (1) needs to go to a store or database where he can purchase or obtain a license on the Work or (2) he needs to contact the owner directly in order to obtain permission. However, it is often difficult to locate the store or database where the Work is for sale or can otherwise be obtained legally (e.g. via creative commons). It is also difficult to identify and contact the owner of a Work as most often his name and contact details are not mentioned on the Work. For users that are able to identify and contact the owner it is difficult to negotiate a license because they lack the legal knowledge.

When the owner of a Work intends to sell licenses on his Work, he can offer it to an online or offline store or database where it is put for sale. However, the owners of the store/database don't accept all works and charge a significant commission. Moreover, not all users will visit these stores/databases. Users that encounter the Work on blogs, social media, websites, online radio (or wherever) and want to buy a license on the Work cannot be served directly. Some users looking for a particular Work will not find the Work of the owner.

An example applied to pictures:

People search images via Google images or find them via social media. Most often they don't have the means to identify and contact the owner and lack the legal knowledge to negotiate a license with the owner if they can locate and contact him. In short, the Internet user doesn't have the means to buy random pictures found on the Internet legally. As a consequence, many use pictures illegally without paying for them, even if they would be willing to pay.

When a photographer wants to sell his work, he can either put his name next to his work with the question to contact him for a license or offer it to one of the photo sale websites such as Getty images and Photolia. He can also opt to offer it for free and license it under a creative commons license.

The photographer currently doesn't have a licensing mechanism that follows his picture. When he sells a picture to a buyer, the license information is lost. When a third party encounters the picture (e.g. on the website, blog, feed, social media) that party doesn't know to whom the picture belongs and under what condition he can obtain a license.

Therefore, there is need in the art for systems and methods for providing a licensing means that allows authors to associate an identifier with their works such that their works can be identified by third parties interested in purchasing, licensing or otherwise transacting with their works. These and other features and advantages of the present invention will be explained and will become obvious to one skilled in the art through the summary of the invention that follows.

### SUMMARY

Accordingly, it is an object of an embodiment of the present invention to provide a licensing means that allows authors to associate a identifier with their works such that their works can be identified by third parties interested in purchasing, licensing or otherwise transacting with their works. The following summary of the invention lays out some of the embodiments for accomplishing these features and is supported by the detailed specification below.

According to an embodiment of the present invention, A system for providing users the ability to sell and/or purchase a license for a work from any computing device comprising: a processor; a non-transitory, computer-readable memory; a database communicatively connected to said processor and said memory; instructions stored in said memory and executable by said processor, wherein said instructions define one or more modules comprising: a registration module configured to receive and store registration information relating to one or more of an author and a creative work, receive and store licensing information associated with one or more of said author and said creative work, generate an identification code for said author wherein said identification code comprises an identifier associated with one or more of said author and a creative work; provide said identification code to said author; and a licensing module configured to receive a request for licensing information for a creative work comprising at least said identification code, identify the author said creative work based at least in part on said identification code, provide available licensing information for said creative work; wherein said system is accessible via a communications network.

According to an embodiment of the present invention, the licensing module is further configured to: process a licensing transaction for a work associated with the identification code; and provide a license for said work based on licensing information stored and associated with said identification code.

According to an embodiment of the present invention, the licensing module offers to sell more than one type of license for said work.

According to an embodiment of the present invention, the licensing information comprises one or more conditions for licensing said one or more works.

According to an embodiment of the present invention, the one or more conditions are predefined by the system.

According to an embodiment of the present invention, the one or more conditions are customizable or negotiated by an owner of said one or more works.

According to an embodiment of the present invention, the registration information comprises information about said one or more works, a digital copy of said one or more works in the form of a computer file, owner information, author information, and transaction information.

According to an embodiment of the present invention, the registration module is further configured to tag said identification code to said creative work.

According to an embodiment of the present invention, the identification code is used to identify the owner of said one or more works.

According to an embodiment of the present invention, a portion of said identification code comprises one or more of a hyperlink to said licensing module provided by said system, computer code providing for the display of licensing information, computer code for retrieving licensing information from said system.

According to an embodiment of the present invention, the licensing module is configured to receive and process a request comprising one or more of a licensing information request for one or more works, request to identify the owner of said one or more works, request to provide licensing information for said one or more works, and request process a licensing transaction for said one or more works.

According to an embodiment of the present invention, a request for licensing information may be initiated by inserting a digital copy of a work and its associated identification code into a designated area of said licensing module, or by clicking the identification code.

According to an embodiment of the present invention, a method for licensing a creative work from any computing device, comprising the steps of: receiving and store registration information relating to one or more of an author and a creative work, receiving and store licensing information associated with one or more of said author and said creative work, generating an identification code for said author wherein said identification code comprises an identifier associated with one or more of said author and said creative work; providing said identification code to said author.

According to an embodiment of the present invention, the method further comprising the step of: processing a licensing transaction for a work associated with said identification code; and providing a license for said work based on licensing information stored and associated with said identification code.

According to an embodiment of the present invention, the tagging comprises storing said identification code in the properties section of said creative work file.

According to an embodiment of the present invention, the tagging comprises embedding said identification code in said creative work file.

According to an embodiment of the present invention, the tagging is performed automatically.

According to an embodiment of the present invention, the method further comprises the step of providing a license for the creative work.

According to an embodiment of the present invention, the method further comprising the step of generating and providing transaction documents to the seller and purchaser of the license.

The method of claim 15, further comprising the step of offering for sale one or more types of licenses for said creative work.

According to an embodiment of the present invention, the request for licensing information is made by inserting a digital copy of a registered work into a designated area of a licensing website provided by the computer system.

According to an embodiment of the present invention, the request for licensing information is made by clicking on the identification code of said registered work.

According to an embodiment of the present invention, the licensing information comprises conditions under which a license for said registered work may be granted.

Embodiments of the present invention include the creation and processing of a license code, via one or more computing devices, to be joined to any work so that it can be purchased from any Location (e.g., website, blog, social media, app) on the Internet, mobile network or any other wide area network (WAN) or local area network (LAN).

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is the flow of the registration by an owner.

FIG. 2 is the flow from making a picture to distributing it on the Internet making use of an embodiment of the present invention.

FIG. 3 is the flow from FIG. 2, but making use of the automatic configuration of a camera.

FIG. 4 is the use of an embodiment of the present invention by means of an Android phone.

FIG. 5 is the flow of the purchase of a license on a picture through an embodiment of the present invention.

FIG. 6 is the flow of the quick purchase of a picture through an embodiment of the present invention.

FIG. 7 is the flow of an embodiment of the present invention on a higher level.

FIG. 8 is the high level flow of the purchase of a picture through an embodiment of the present invention.

FIG. 9 is the flow of the purchase of a song through the Invention.

FIG. 10 illustrates a schematic overview of a computing device, in accordance with an embodiment of the present invention.

FIG. 11 illustrates a network schematic of a system, in accordance with an embodiment of the present invention.

FIG. 12 is a process flow of an exemplary method in accordance with an embodiment of the present invention.

FIG. 13 is a process flow of an exemplary method in accordance with an embodiment of the present invention.

### DETAILED DESCRIPTION OF THE INVENTION

Embodiments of the present invention are directed to providing a computer implemented dynamic licensing method and technique that provides users the ability to sell and/or purchase a license on a work from any computing device. The terms “work” and “creative work” shall be regarded as equivalent terms throughout this application. Preferred embodiments of the present invention are provided by one or more web-based computing devices providing users the ability to: (i) list a work as available for licensing; and (ii) purchase and retrieve a license to use a work for an intended purpose.

According to an embodiment of the present invention, the system and method is accomplished through the use of one or more computing devices. As shown in FIG. 10, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103 and a communications means (e.g., NIC, WI-FI, CDMA, GSM, 3G, 4G, Ethernet connection, fiber connection) 104. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

Referring to FIG. 11, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 11, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, an Owner accesses a computer and accesses the systems and associated methods by way of a communications connection between components of the system and the computer utilized by the Owner. The system may provide the Owner with the ability to register and enter transaction information (e.g., information to receive payments). In a preferred embodiment of the present invention, the system then grants the Owner an identification code. This identification code may be any Code, including but not limited to one or more of an automatically generated unique code, an email address, Twitter ID etc. One of ordinary skill in the art would appreciate that there are numerous types of identification codes that may be utilized with embodiments of the present invention, and embodiments of the present invention are contemplated for use with any appropriate identification code.

According to an embodiment of the present invention, the system retains the license information under which the Owner is willing to license his Work. The term “Owner” as used herein shall include one or more owners. Although the Owner is often synonymous with the author/creator of the work, this is not necessarily the case. The term as used herein refers to any entity that has proper legal title to the work and has a legal right to license the work.

After registration the Owner can add the identification code to electronic/digital copies of his Work (e.g. in the properties of the file) and disseminate/display/distribute his Work through the Internet (e.g. via his blog, Facebook, Twitter, Instagram) or other LAN or WAN.

The easiest way to add or tag the identification code to a Work is to put it in the properties of a file (e.g., metadata, file information). However, it is also possible to add it in other ways (e.g. in the filename). For example, a filename may be coupled with a unique ID or code that the system could interpret and check against stored codes for the purpose of identifying licenses associated with the file (i.e., the Work). In other embodiments, the system can be configured to add data to the Work in a manner that does not alter the format of the Work, but retains the identification code for use with the system. For instance, a JPEG file can be appended with additional data that can be retrieved by a system that knows where to look for the information. The additional data could be, for instance, appended after the end of the file or at a specified block or byte. In these embodiments, the system would be configured to search or otherwise review files for this additional data in order to retrieve the identification code.

Some services (e.g. Twitter at the moment of the submitting of this application) clear the property information when a Work (e.g. a picture) is tweeted (distributed via Twitter). In such case the properties can't be used but other means that are generally available can be used, e.g. the identification code can be tagged to the file itself by means of a watermark or other stamp that is part of the file, by means of the writing of the identification code on the file with an editor (e.g. writing the code on the picture with a photo editor that allows writing on the picture and subsequently saving the picture; the system will be able to recognize the Code stored that way) the identification code can simply be disseminated together with the Work (e.g. in the same tweet) in such a way that the Code and the Work are distributed together; or the system may be configured to provide an Owner the ability to insert data into the file (i.e., Work) in such a manner that does not affect the file itself, but can allow the system to later retrieve the identification code from the file, making the presence of the identification code imperceptible to the service receiving the Work. It is possible to request (or even require as part of the license conditions) that the licensee must keep the identification code intact and must display the Code next to the Work at all times. Other solutions are for the Owner to upload the Work to a database (or have it crawled by an engine to store it in a database) with the identification code or a referral to it. The system will then relate the Work uploaded to the system to the copy of the Work stored in its database, e.g. by reverse image search or other algorithm, and retrieve the identification code.

Another interesting way of using an embodiment of an Invention is to add a JavaScript to the Work. Some websites such as the website from the Belgian journal De Tijd implement a JavaScript in such a way that when text is copy-pasted to another location, a copyright notice is added to the copied text. The same system can be used to offer the User the license information and directly purchase the Work through the Invention.

On social networks, the login name of the social network may be used as identification code: e.g. the Twitter name on Twitter.

Whenever in this Application it is written that the Code is joined, added to the Work or put in the properties, it is understood that one of these different options is used.

When the Work is distributed with the identification code, any user that finds the Work, can easily purchase a license by copying the picture and the identification code of the Owner in the specifically designed Website or by clicking on the identification code, which causes the same Website to open. The user can now complete the transaction by accepting the license conditions and paying. The Website automatically completes the payment process and provides the user with a license.

Referring now to a preferred embodiment of the present invention in more detail, in FIG. 1 there is shown the flow of the process of the Invention when the Owner registers.

FIG. 1:

An Owner accesses a Computer 10 and opens a web browser 12 (such as, but not limited to, internet explorer, chrome or Firefox).

Via such web browser he accesses a Website 14 that is specifically designed to implement an exemplary embodiment of the present invention.

On the Website he registers 14 (e.g. by giving his personal data such as name, e-mail address etc. or via other means such as his Twitter or Facebook account).

On the Website the Owner also enters his transaction information 18. This is the information that allows him to receive payments, such as but not limited to, his PayPal account, bank account etc.

The Website also contains the license details 20 under which the Owner offers to license his Works. In this example the license conditions are predefined and cannot be altered by the Owner. In other embodiments, the license conditions may be customizable.

In certain embodiments, an Owner may be provided a plurality of licenses to associate with his works. This allows the Owner to offer different licenses for different works. For instance, an Owner may request different licensing rates for different works, depending on quality, popularity, utilization or other factors.

Upon registration, the Website returns a code that enables identification of the Owner for future transactions.

FIG. 2:

In FIG. 2 there is shown the flow of the process of an exemplary embodiment of the present invention when the Owner of a picture uses this exemplary embodiment after having registered as shown in FIG. 1.

A photographer makes a picture 24 using a standard digital photo camera 26. The photographer then transfers 28 the picture onto a Computer 30. The transferring 28 may (amongst others) occur by taking the memory card from the digital camera and putting it in the card reader slot of the Computer 30. On a Windows computer, the photographer then opens Windows explorer and sees the memory card displayed in the list on the left hand side.

The photographer then navigates 32 to the picture he wants to use. The photographer right-clicks on the picture 24 and clicks “properties” 34 on the pop-up window. The photographer clicks on the “Details” tab to access the properties of the picture. The photographer chooses a field in the properties, e.g. the field “subject”, “comments” or “copyright” and enters his identification code 22 in the value field. He then clicks apply to save the information.

The photographer then transfers 36 the picture to the Internet 38, e.g. by posting it on his blog (e.g. via WordPress), uploading it via Flickr etc.

FIG. 3:

The photographer performs the same operation as under FIG. 2, but now he decides to preconfigure his digital camera in order to have it display his identification code automatically in the picture properties. So he doesn't add the identification code via a Computer, but directly via his digital camera.

A photographer has a digital camera 26, e.g. a Nikon D300. He enters the setup menu—copyright information 40. He enters his identification code 22 in the field copyright notice. Now all his pictures have his identification code in their exif data.

The photographer makes a picture 24. This picture has the identification code in the exif data. The photographer then transfers 28 the picture on a Computer 30. The transferring 28 may (amongst others) occur by taking the memory card from the digital camera and putting it in the card reader slot in the Computer 30. On a Windows computer, the photographer then opens Windows explorer and sees the memory card displayed in the list on the left hand side.

The photographer then transfers 36 the picture to the Internet 38, e.g. by posting it on his blog (e.g. via WordPress), uploading it via Flickr etc.

FIG. 4:

The photographer performs the same operation as under 3. However, now he uses an Android phone 42 with an exif editor (such as, but not limited to ExifTool) installed.

The photographer takes a picture 24. He then opens a terminal box or a DOS box and types the following:

“exiftool-ImageDescription=“Man without head”-Comment=“Man without head”-artist=“photographerName”-copyright=“XXX”/path/and/filename/of/your/photo.jpg.”

“XXX” is the identification code. The identification code 22 is now added to the picture 24.

The photographer then uploads 36 the picture 24 to the Internet 38.

The photographer may also use a tool that automatically adds his identification code to all his pictures taken from his Android phone.

FIG. 5

A user accesses his Computer 46. He opens a search engine such as Google 48. He enters a search term for a picture and finds a picture 52 via Google images 50.

He opens the Website 54. The Website is specifically designed to implement an exemplary embodiment of the present Invention. He loads the picture 52 in the Website, e.g. by pasting the image URL, by drag and drop, by first storing the picture on his Computer and later uploading it etc.

The Website analyses the pictures and looks into the picture properties 66. In case the Website doesn't find the identification code, no transaction will occur. The user receives a no transaction message 62.

In case the Website finds the identification code in the properties 58, the user is shown the license conditions applicable to the picture 68 and is offered the possibility to buy a license on the picture 58. If the user agrees, the Website initiates a payment process, e.g. by PayPal or credit card 60. After completion of the payment process transaction documents, e.g. license document and invoice 64 are sent to the user 46 and to the photographer 72. The transaction details may also be stored in a database 70.

FIG. 6

In FIG. 6 a picture 76 is placed on a blog. Next to the blog a license information icon or text is displayed 78. By clicking on this icon or text 78 the Website 54 automatically opens. The picture 76 is shown together with the applicable license conditions 68. This happens because the identification code is inserted in the license information code and allows the Website to match the picture with the correct license and transaction information (it is also possible that the user needs to open the Website and copy or upload the picture and the identification code to it). The user is offered to buy a license 58 on the picture 76. In case the user opts to buy a license, the payment process 60 is initiated and the transaction documents 64 are generated by the Website and sent to the photographer (i.e. license seller) and the user (i.e. license purchaser). The transaction documents are stored in a database 70.

FIG. 7

A user 80 found a picture 82 on any Location 96 and wants a license on the picture 82. The license information 84 is joined in the properties of the picture, e.g. by means of a code in the exif data.

The user 80 opens a Tool 86 and inserts the picture 82 in the Tool 86 by draging and dropping or uploading 88. The Tool 86 opens the license conditions 90 and allows the user 80 to buy a license 90. If the user 80 opts to buy the license, he can proceed to payment 92. The transaction documents (e.g. payment confirmation, invoice, license document etc.) are generated and sent 94 to the user 80.

The Tool 86 will usually be a separate software means, but may also be embedded in the Location 96.

FIG. 8.

FIG. 8 shows the same process as FIG. 7, but here the user 80 can directly buy the picture 82 by clicking or otherwise activating a Tool 90 through the license info 84. This is possible when the license info is displayed as e.g. a hyperlink or other means that allows activating a Tool. A Tool 90 opens and the process of FIG. 7 is initiated.

FIGS. 1 to 8 show the process for the purchase of a license on a picture. However, it is possible to use embodiments of the present invention for the purchase of any Work, e.g. music, movies, books etc. In FIG. 9 the purchase of a song is shown.

FIG. 9.

A user listens to a song 98 on his iPad 100 (e.g. online radio). The music app on the iPad will typically display information of the song 110 (e.g. title, artist . . . ). With the Invention, the music app will also display purchase information 108. The purchase information is stored and processed in a similar way as the song information. The purchase information may be an identification code or may contain the entire license and transaction information. In the case of FIG. 9 a referral code is used. When the user clicks the buy this song button 108, a request comprising the referral code will go to a server 102 that is designed to implement the Invention. The request causes the server 102 to send the license information 104 and transaction information 106 for song 98 to the iPad 100 of the user.

The license information 104 and transaction information 106 is displayed on the iPad 100. In case the user wants to buy the song, the transaction process 112 is initiated. This transaction process includes the acceptance of the license conditions by the user and the completion of the payment via the payment process 114 (in this case with PayPal but other payment means are possible).

Upon receipt of the payment, the server 102 sends a transaction confirmation (e.g. license document) to the user and the transaction confirmation and payment to the rightsholder 118 (it is possible that the payments are split and that a payment goes directly from the user to the rightsholder).

While the foregoing description of the invention enables one of ordinary skill to make and use what is considered presently to be the best mode thereof, those of ordinary skill will understand and appreciate the existence of variations, combinations, and equivalents of the specific embodiment, method, and examples, but all embodiments and methods within the scope and spirit of the invention as claimed.

An example applied to pictures:

Embodiments of the present Invention, when applied to pictures, comprises a licensing format and technique that follows the picture/Work because it is embedded in the picture or it's properties or is otherwise joined to it (or displayed next to it).

When the photographer tweets the picture, uploads it on a blog, uses it on social media etc., the licensing information will follow the picture. When a third party buys the picture, the licensing information will still follow the picture. Every third party that encounters the picture will still be able to identify the Owner and obtain his own legal copy by purchasing a license thanks to the added licensing information.

When someone finds a picture on the Internet, the system will allow him/her to contact the Owner and purchase the picture (a license on it). The user will find a predefined set of licenses that are human and/or machine readable.

According to an embodiment of the present invention, the identification code may consist of a Code that is unique to the Owner, the picture or the license. When the Code is used (this can be done by uploading/dropping the entire picture in an electronic recipient designed for this task, e.g. on a website or in an application, a tool, widget, overlay etc., by pasting the Code as URL, by using the Code as email address, by using the Code via social media, by clicking on the Code or on the picture, by sending an SMS, MMS, email etc.) the Code will activate a mechanism that allows the Owner to grant permission on an individual or automated basis. A payment mechanism may be attached (e.g. SMS, PayPal or visa or credit system or other) in order to allow the transaction to be completed. An invoice mechanism may be added to, as well as a system that provides other information and data such as a raw version of the picture, model release forms etc.

The Code may do more than just refer to a license under which the user is granted the right to use the picture. It may be used to upload a means<display, application, app, website, program, page, chat, social media . . . any interactive tool>that allows the user to interact with the photographer (in person or via an automated system). Said means enables the user to purchase the license of his choosing.

The Code can contain several pieces of information. The Code may be unique to the Owner (or group of owners) or to the individual picture (or group of pictures) or to a certain individual license (or license type). The Code may allow a check on the authenticity of the picture and/or the reliability of the Owner (feedback mechanism).

According to an embodiment of the present invention, the license may be issued by a third party. This third party may act as trusted party for payment purposes.

When the license is sold, automatic access may be given to additional documents, e.g. raw versions, model releases etc.

In preferred embodiments of the present invention, the licenses will be a predefined set of licenses, just like the creative commons licenses. The licenses offer the user a limited set of choices. Contrary to the creative commons licenses, the licenses associated with exemplary embodiments of the present invention will be commercial and require payment. This differentiates licenses utilized by embodiments of the invention from creative commons licenses. With creative commons licenses, there is no need for the Owner and the user to get into contact. The Owner most often doesn't even know that a user just licensed his Work. According to exemplary embodiments of the present invention, the Owner will be informed that a user purchased a license and he will receive payment.

So most often the licenses will be a set of predefined licenses. However, it may be possible for the Owner to configure the parameters of the licenses (e.g. he may set the price options, detail that he offers warranties, promise to deliver raw versions of the Work, define duration of the license, define variable rate licensing based on one or more criteria). One of ordinary skill in the art would appreciate there are numerous parameters for licenses that could be utilized with embodiments of the present invention, and embodiments of the present invention are contemplated for use with any appropriate license parameters. It is also possible that embodiments of the present invention initiate a negotiation process between the user and Owner. The negotiation process could be automated and completely handled by the system on the Owner's behalf based on predefined negotiation criteria set forth by the Owner.

In the text above the actor is indicated as “photographer”. However, it can be anybody who is entitled to sell licenses of the picture.

The invention here is described for photographs/pictures. However, it works for any kind of Works, such as (but not limited to) music, video, software, text, books, lyrics, audio fragments etc.

According to embodiments of the present invention, The Code needs to be joined to the picture/Work, or it can simply be displayed next to it. But most likely it will be put in the properties or embedded in the Work itself, e.g. as watermark. The Code is human and/or machine readable.

According to embodiments of the present invention, the Code may also contain a link to a central database with more information on the Work.

The advantages of the present invention include, without limitation, the possibility to purchase Works from any Location and for Owners to sell their Works from any Location. Also, it will be able to monitor compliancy of Rights on electronic or digital environments such as the Internet and mobile webs.

According to embodiments of the present invention, the system may allow automated negotiation and parameterization of the license details. As noted above, the automation may be based on pre-defined or automatically generated criteria for negotiations/parameterizations. One of ordinary skill in the art would appreciate that there are numerous ways in which the negotiation and/or parameterization components could be configured, and embodiments of the present invention are contemplated for use with any such configuration.

The identification code may be a custom generated Code. The advantage of such a generated Code is that it can comprise more information than only identification. E.g. it may contain license information such as license type, price etc.

### Exemplary Embodiments

Turning now to FIG. 12, an exemplary embodiment of a method for providing a Code to an Owner is shown. At step 301, the process starts with an Owner contacting the system in order to get a Code. At step 302, the system receives the request from the Owner and either logs the Owner in based on previously registered information, or provides the Owner the ability to register as a new user (a separate process that requires the Owner to provide certain personal and/or login information associated with the Owner).

At step 303, the Owner has been logged into the system and the Owner is provided one or more options associated with possible licenses the Owner may be interested in. The Owner will then select the type and parameters of the licenses the Owner desires. The system receives this selection and at step 304, the system utilizes the received selections to generate one or more appropriate Codes for the Owner. The system may also store these Codes for later retrieval and utilization with respect to licensing transaction requests from users. Codes may be stored in one or more tangible storage mediums, including, but not limited to, a database, a file, a data store a data repository, or any combination thereof.

At step 305, the system transmits the one or more Codes to the Owner. After transmission of the Code(s) is completed, the process terminates at step 306.

Turning now to FIG. 13, an exemplary embodiment of a method for processing a licensing transaction is shown. At step 401, the process starts with a User contacting the system in order to get a license based on a Code they have identified associated with a Work of an Owner. At step 402, the system receives the license request from the User. The system may require the User to identify themselves by logging into the system, or in other embodiments, the system may allow the User to complete a licensing transaction without registering with the system.

At step 403, the system has received one or more Codes and/or Works from the User and retrieves any licensing information associated with the Code(s) and/or Works. One the licensing information has been retrieved, the system transmits the available licensing information to the User.

At step 404, the system receives a license selection from the User. At this step, the User will also provide payment information in order to complete the financial portion of the licensing transaction.

At step 405, the system processes payment for the selected license(s) and transmits the licenses to the User. The system may also store the license and transaction information so that the Owner may review the licensing and transaction information at their convenience. After transmission of the license(s) is completed, the process terminates at step 406.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

### DEFINITIONS AND GENERAL INFORMATION

Wherever in this Application one of the following terms is used, such term has the meaning defined below:

Application: this provisional patent application.

Owner: the natural or legal person who holds the Rights in a Work. This can be the creator of the Work or the person who legally obtained the rights in the Work.

Code: any sign, symbol, string of characters or other means that enables the identification of an Owner, work or license, such as integer strings, strings with ascii characters, email addresses, URL, digital means, electronic means, visual means, social media login (e.g. Facebook, Twitter, Google account . . . )

Internet: the world wide web or any other electronic or digital network that enables dissemination/distribution of Works.

Rights: any rights in or to any copyright, data base right, registered design, design right, patent, utility model, trade mark, brand name, service mark, trade name, business name or know how.

Work: any work that can be licensed under the Rights, such as, but not limited to pictures, music, movies, audio, books, texts, software or any other content.

Location: any means that enables a user to meet or access a Work via any Tool or Device.

Tool: any software or electronic means, such as apps, websites, overlays, plug ins, software programs or interfaces.

Computer: any general purpose computer (desktop or laptop) or other device that has similar capabilities such as but not limited to smartphone, iPad, digital television, electronic notebook, e-reader, digital radio, player, console, etc.

Website: a website or Tool or app that has capabilities similar to a website.

Wherever in the Application “he”/male is written, “she”/female is deemed to be included.

The invention was not created under government contract.

1. A system for providing users the ability to sell and/or purchase a license for a work from any computing device comprising:
a processor;
a non-transitory, computer-readable memory;
a database communicatively connected to said processor and said memory;
instructions stored in said memory and executable by said processor, wherein said instructions define one or more modules comprising:
a registration module configured to
receive and store registration information relating to one or more of an author and a creative work,
receive and store licensing information associated with one or more of said author and said creative work,
generate an identification code for said author wherein said identification code comprises an identifier associated with one or more of said author and said creative work;
provide said identification code to said author; and
a licensing module configured to
receive a request for licensing information for a creative work comprising at least said identification code,
identify the author of said creative work based at least in part on said identification code,
provide available licensing information for said creative work; wherein said system is accessible via a communications network.

2. The system of claim 1, wherein said licensing module is further configured to:
process a licensing transaction for a work associated with said identification code; and
provide a license for said work based on licensing information stored and associated with said identification code.

3. The system of claim 2, wherein said licensing module offers to sell more than one type of license for said work.

4. The system of claim 1, wherein said licensing information comprises one or more conditions for licensing said one or more works.

5. The system of claim 4, wherein said one or more conditions are predefined by the system.

6. The system of claim 4, wherein said one or more conditions are customizable or negotiated by an owner of said one or more works.

7. The system of claim 1, wherein said registration information comprises information about said one or more works, a digital copy of said one or more works in the form of a computer file, owner information, author information, and transaction information.

8. The system of claim 1, wherein said registration module is further configured to tag said identification code to said creative work.

9. The system of claim 1, wherein said identification code is used to identify the owner of said one or more works.

10. The system of claim 1, wherein a portion of said identification code comprises one or more of a hyperlink to said licensing module provided by said system, computer code providing for the display of licensing information, computer code for retrieving licensing information from said system.

11. The system of claim 10, wherein said licensing module is configured to receive and process a request comprising one or more of a licensing information request for one or more works, request to identify the owner of said one or more works, request to provide licensing information for said one or more works, and request process a licensing transaction for said one or more works.

12. The system of claim 10, wherein a request for licensing information may be initiated by inserting a digital copy of a work and its associated identification code into a designated area of said licensing module, or by clicking the identification code.

13. A method for licensing a creative work from any computing device, comprising the steps of:
receiving and store registration information relating to one or more of an author and a creative work,
receiving and store licensing information associated with one or more of said author and said creative work,
generating an identification code for said author wherein said identification code comprises an identifier associated with one or more of said author and said creative work;
providing said identification code to said author.

14. The method of claim 14, further comprising the step of:
processing a licensing transaction for a work associated with said identification code; and
providing a license for said work based on licensing information stored and associated with said identification code.

15. The method of claim 14, wherein said tagging comprises storing said identification code in the properties section of said creative work file.

16. The method of claim 14, wherein said tagging comprises embedding said identification code in said creative work file.

17. The method of claim 14, further comprising the step of providing a license for the creative work.

18. The method of claim 17, further comprising the step of generating and providing transaction documents to the seller and purchaser of the license.

19. The method of claim 14, further comprising the step of offering for sale one or more types of licenses for said creative work.

20. The method of claim 14, wherein said request for licensing information is made by inserting a digital copy of a registered work into a designated area of a licensing website provided by the computer system.
